(19) United States
(12) Patent Application Publication
(10) Pub. No.: US 2024/0316992 A1
(43) Pub. Date: Sep. 26, 2024

(54) APPARATUS FOR ESTIMATING WEAR AMOUNT OF TIRE AND METHOD THEREOF

(71) Applicants: Hyundai Motor Company, Seoul (KR); Kia Corporation, Seoul (KR)

(72) Inventors: Young Gul Cho, Seoul (KR); Seung Eun Kim, Seoul (KR); Nam Chung Paik, Goyang-si (KR); Seung Woo Ha, Seoul (KR); Ja Ho Koo, Seoul (KR); Tae Young Heo, Yongin-si (KR); Kyu Nam Choi, Incheon (KR)

(21) Appl. No.: 18/353,299

(22) Filed: Jul. 17, 2023

(30) Foreign Application Priority Data
Mar. 24, 2023 (KR) 10-2023-0038647

(51) Int. Cl. B60C 11/24; G06F 17/18

(52) U.S. Cl. CPC B60C 11/246; G06F 17/18; G06N 7/01

(57) ABSTRACT

An embodiment apparatus for estimating a wear amount of a tire includes a memory storing a model configured to learn a correlation between a driving pattern and the wear amount of the tire and a controller configured to estimate the wear amount of the tire corresponding to the driving pattern of a driver based on the model.

### CROSS-REFERENCE TO RELATED APPLICATIONS

This application claims the benefit of Korean Patent Application No. 10-2023-0038647, filed on Mar. 24, 2023, which application is hereby incorporated herein by reference.

### TECHNICAL FIELD

The present disclosure relates to an apparatus for estimating the wear amount of a tire and a method thereof.

### BACKGROUND

In general, a tire mounted on a wheel of a vehicle is made of rubber having a specified elasticity in order to mitigate impact from a road surface and is filled with air at an appropriate pressure.

Because wear is progressed by frictional force with the road surface when tires are driven for a long time, when the tire is worn by a certain amount (e.g., 4 mm), the tire must be replaced with a new tire. When the vehicle is driven while the tire is worn beyond the wear limit, the tire may be damaged to cause an accident.

Tires are marked with a symbol to check the amount of wear. Accordingly, a driver may determine the wear amount of the tire and the replacement timing of the tire by checking the symbol with the naked eye.

However, because the symbol is marked at a specified position of the tire, the driver must frequently check the symbol before driving and may miss the right replacement time of the tire because the driver arbitrarily determines the tire replacement time. In this case, a tire worn over a certain amount may cause a major accident.

As a conventional technique, a technique for informing a driver of a tire replacement time by installing a wire on the inner edge of a tire and outputting a warning sound when the wire is disconnected due to wear of the tire has been proposed.

According to such a conventional technique, because the wires must be installed on the inner edge of the tire, the process of manufacturing a tire may be complicated, and the wires may be disconnected by high-speed rotation of the tire even when the tire is not worn.

The matters described in this background section are intended to promote an understanding of the background of embodiments of the disclosure and may include matters that are not already known to those of ordinary skill in the art.

### SUMMARY

The present disclosure relates to an apparatus for estimating the wear amount of a tire and a method thereof. Particular embodiments relate to a technique for estimating the wear amount of a tire based on a regression model.

Embodiments of the present disclosure can solve problems occurring in the prior art while advantages achieved by the prior art are maintained intact.

An embodiment of the present disclosure provides an apparatus for estimating a wear amount of a tire that includes a model that learns a correlation between a driving pattern of a driver and a wear amount of a tire and estimates a wear amount of a tire corresponding to a driving pattern of a driver based on the model, such that it is possible to estimate a tire replacement time with high accuracy without requiring the driver to frequently check the wear amount of the tire before driving, and a method thereof.

Another embodiment of the present disclosure provides an apparatus for estimating a wear amount of a tire that includes a model that learns a correlation between a driving pattern of a driver and a wear amount of a tire, estimates a wear amount of a tire corresponding to a driving pattern of a driver based on the model, and provides the wear amount of the tire to the driver such that the driver may easily check the tire condition at any time even while driving, and a method thereof.

Still another embodiment of the present disclosure provides an apparatus for estimating a wear amount of a tire that includes a model that learns a correlation between a driving pattern of a driver and a wear amount of a tire and estimates a wear amount of a tire corresponding to a driving pattern of a driver based on the model, such that it is possible to notify the driver of tire replacement when the wear amount of the tire exceeds a threshold value, thereby allowing the driver to replace the tire at an appropriate tire replacement time.

Still another embodiment of the present disclosure provides an apparatus for estimating a wear amount of a tire that includes a model that learns a correlation between a driving pattern of a driver and a wear amount of a tire, estimates a wear amount of a tire corresponding to a driving pattern of a driver based on the model, and provides the wear amount of the tire to an external vehicle management server, such that the vehicle management server may provide a potentiometer service, an aftermarket service, or a tire replacement reservation service for each vehicle.

The technical problems solvable by embodiments of the present disclosure are not limited to the aforementioned problems, and any other technical problems not mentioned herein will be clearly understood from the following description by those skilled in the art to which the present disclosure pertains. Also, it may be easily understood that the objects and advantages of embodiments of the present disclosure may be realized by the units and combinations thereof recited in the claims.

According to an embodiment of the present disclosure, an apparatus for estimating a wear amount of a tire includes storage that stores a model that learns a correlation between a driving pattern and the wear amount of the tire and a controller that estimates the wear amount of the tire corresponding to a driving pattern of a driver based on the model.

According to an embodiment, the controller may collect at least one of a longitudinal acceleration, a lateral acceleration, a gear ratio, a steering angle, a slope, a yaw rate, a vehicle speed, a tire air pressure, a mileage, or a combination thereof through a vehicle network.

According to an embodiment, the model may include one of Bayesian Ridge regression and Huber regressor.

According to an embodiment, the controller may assign a highest weight to the mileage when the model is Bayesian Ridge regression.

According to an embodiment, the controller may assign a highest weight to the vehicle speed when the model is Huber regressor.

According to an embodiment, the controller may grasp the driving pattern of the driver based on at least one of braking energy, a count ratio of longitudinal acceleration-lateral acceleration, an amount of work, a gear ratio, a steering angle, a slope, a yaw rate, a vehicle speed, a right front wheel tire air pressure, a left front wheel tire air pressure, a mileage, or a combination thereof.

According to an embodiment, the controller may provide the wear amount of the tire to the driver.

According to an embodiment, the controller may warn the driver to replace the tire when the wear amount of the tire exceeds a threshold value.

According to an embodiment, the controller may provide the wear amount of the tire to a vehicle management server.

According to an embodiment, the controller may store different models corresponding to a type of vehicle and a type of tire.

According to another embodiment of the present disclosure, a method of estimating a wear amount of a tire includes storing, by storage, a model that learns a correlation between a driving pattern and the wear amount of the tire, and estimating, by the controller, the wear amount of the tire corresponding to a driving pattern of a driver based on the model.

According to an embodiment, the estimating of the wear amount of the tire may include collecting, by the controller, at least one of a longitudinal acceleration, a lateral acceleration, a gear ratio, a steering angle, a slope, a yaw rate, a vehicle speed, a tire air pressure, a mileage, or a combination thereof through a vehicle network.

According to an embodiment, the estimating of the wear amount of the tire may include assigning, by the controller, a highest weight to the mileage when the model is Bayesian Ridge regression.

According to an embodiment, the estimating of the wear amount of the tire may include assigning, by the controller, a highest weight to the vehicle speed when the model is Huber regressor.

According to an embodiment, the estimating of the wear amount of the tire may include grasping, by the controller, the driving pattern of the driver based on at least one of braking energy, a count ratio of longitudinal acceleration-lateral acceleration, an amount of work, a gear ratio, a steering angle, a slope, a yaw rate, a vehicle speed, a right front wheel tire air pressure, a left front wheel tire air pressure, a mileage, or a combination thereof.

According to an embodiment, the estimating of the wear amount of the tire may include providing, by the controller, the wear amount of the tire to the driver.

According to an embodiment, the estimating of the wear amount of the tire may include warning, by the controller, the driver to replace the tire when the wear amount of the tire exceeds a threshold value.

According to an embodiment, the estimating of the wear amount of the tire may include providing, by the controller, the wear amount of the tire to a vehicle management server.

According to an embodiment, the storing of the model may include storing, by the storage, different models corresponding to a type of vehicle and a type of tire.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a block diagram illustrating a configuration of an apparatus for estimating a wear amount of a tire according to an embodiment of the present disclosure;

FIG. 2 is a diagram illustrating a process of selecting the type of model provided in an apparatus for estimating a wear amount of a tire according to an embodiment of the present disclosure;

FIG. 3 is a diagram illustrating a count ratio of a longitudinal acceleration-lateral acceleration region determined by a controller provided in an apparatus for estimating a wear amount of a tire according to an embodiment of the present disclosure;

FIG. 4 is a block diagram illustrating a vehicle management system to which an apparatus for estimating a wear amount of a tire according to an embodiment of the present disclosure is applied;

FIG. 5 is a flowchart of a method of estimating a wear amount of a tire according to an embodiment of the present disclosure; and

FIG. 6 is a block diagram illustrating a computing system for executing a method of estimating a wear amount of a tire according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when it is displayed on other drawings. Further, in describing the embodiments of the present disclosure, a detailed description of the related known configuration or function will be omitted when it is determined that it interferes with the understanding of the embodiments of the present disclosure.

In describing the components of the embodiments according to the present disclosure, terms such as first, second, A, B, (a), (b), and the like may be used. These terms are merely intended to distinguish the components from other components, and the terms do not limit the nature, order, or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

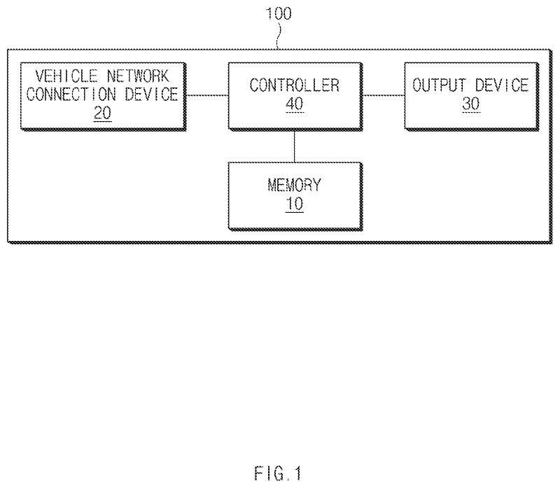

FIG. 1 is a block diagram illustrating a configuration of an apparatus for estimating a wear amount of a tire according to an embodiment of the present disclosure.

As shown in FIG. 1, an apparatus 100 for estimating a wear amount of a tire according to an embodiment of the present disclosure may include a memory (i.e., a storage) 10, a vehicle network connection device 20, an output device 30, and a controller 40. In this case, depending on a scheme of implementing the apparatus 100 for estimating a wear amount of a tire according to an embodiment of the present disclosure, components may be combined with each other to be implemented as one, or some components may be omitted.

Regarding each component, the memory 10 may store a model (e.g., a regression model) that learns a correlation between a driving pattern of a driver and a wear amount of a tire. In this case, the memory 10 may store a plurality of different models for each vehicle type and tire type. In addition, the tire refers to a left front wheel tire and a right front wheel tire of a vehicle.

The memory 10 may store various logic, algorithms, and programs required in the process of estimating a wear amount of a tire corresponding to a driving pattern of a driver based on the model.

The memory 10 may store various logic, algorithms, and programs required in the processes of estimating a wear amount of a tire corresponding to a driving pattern of a driver based on the model and providing the wear amount of the tire to the driver.

The memory 10 may store various logic, algorithms, and programs required in the processes of estimating a wear amount of a tire corresponding to a driving pattern of a driver based on the model and warning the driver to replace the tire when the wear amount of the tire exceeds a threshold value.

The memory 10 may store various logic, algorithms, and programs required in the processes of estimating a wear amount of a tire corresponding to a driving pattern of a driver based on the model and providing the wear amount of the tire to an external vehicle management server.

The memory 10 may include at least one type of a storage medium of memories of a flash memory type, a hard disk type, a micro type, a card type (e.g., a secure digital (SD) card or an extreme digital (XD) card), and the like, and a random access memory (RAM), a static RAM, a read-only memory (ROM), a programmable ROM (PROM), an electrically erasable PROM (EEPROM), a magnetic memory (MRAM), a magnetic disk, and an optical disk type memory.

The vehicle network connection device 20 may provide a connection interface with a vehicle network. In this case, the vehicle network may include a controller area network (CAN), a controller area network with flexible data-rate (CAN FD), a local interconnect network (LIN), FlexRay, a media oriented systems transport (MOST), Ethernet, and the like.

The output device 30 may visually or audibly provide the wear amount of the tire of the vehicle to the driver, and when the wear amount of the tire exceeds a threshold value, notify the driver visually or audibly of tire replacement.

The controller 40 may perform overall control such that each component performs its function. The controller 40 may be implemented in the form of hardware or software, or may be implemented in a combination of hardware and software. Preferably, the controller 40 may be implemented as a microprocessor, but is not limited thereto.

In addition, the controller 40 may estimate the wear amount of the tire corresponding to the driving pattern of a driver based on the model stored in the memory 10.

In addition, the controller 40 may estimate the wear amount of the tire corresponding to the driving pattern of a driver based on the model stored in the memory 10 and provide the wear amount of the tire to the driver.

In addition, the controller 40 may estimate the wear amount of the tire corresponding to the driving pattern of a driver based on the model stored in the memory 10 and warn the driver to replace the tire when the wear amount of the tire exceeds a threshold value.

In addition, the controller 40 may estimate the wear amount of the tire corresponding to the driving pattern of a driver based on the model stored in the memory 10 and provide the wear amount of the tire to an external vehicle management server 300.

In addition, the controller 40 may obtain a longitudinal acceleration, a lateral acceleration, a gear ratio, a steering angle, a slope, a yaw rate, a vehicle speed, a tire air pressure, a mileage, a brake operation, and the like from a vehicle network.

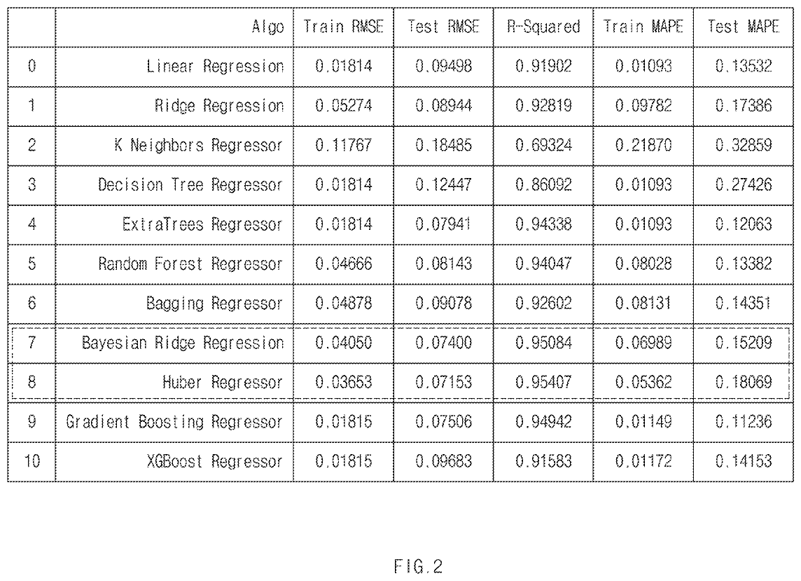

Hereinafter, with reference to FIG. 2, the process of selecting the type of the model will be described in detail.

FIG. 2 is a diagram illustrating a process of selecting the type of model provided in an apparatus for estimating a wear amount of a tire according to an embodiment of the present disclosure.

The model may be implemented as, for example, a regression model. Such a regression model is an algorithm for finding a stochastic or statistical correlation in which an estimated value and an actual value correspond 1:1 and is suitable for estimating the wear amount of a tire. Therefore, it is desired to select the optimal regression model from various regression models such as linear regression, ridge regression, K neighbors regressor, decision tree regressor, extratrees regressor, random forest regressor, bagging regressor, Bayesian ridge regression, Huber regressor, gradient boosting regressor, and XGBoost regressor.

As shown in FIG. 2, for each regression model, Train root mean square error (RMSE), Test RMSE, a determination coefficient (R-Squared), Train mean absolute percentage error (MAPE), and Test MAPE were calculated.

The optimal regression model for estimating the wear amount of a tire corresponding to the driver's driving pattern should have a low Test RMSE and Test MAPE, a small gap between Train RMSE and Test RMSE, and a high R-Squared.

Because there are Bayesian Ridge regression and Huber regressor as the regression models corresponding to this, it is preferable to select Bayesian Ridge regression and Huber regressor as the optimal regression models. In this case, the variables input to the regression model may include a gear ratio, a steering angle, a slope, a yaw rate, a vehicle speed, a left front wheel tire air pressure, a right front wheel tire air pressure, and a mileage as basic variables, and include a braking energy, an amount of work, and the count percentage of the longitudinal acceleration-lateral acceleration region as derived variables. In this case, the slope means the slope of the road on which the vehicle travels.

When Bayesian Ridge regression is selected as the optimal regression model, the controller 40 may estimate the wear amount (Y) of a tire corresponding to the driver's driving pattern based on, for example, the following Equation 1. In this case, Equation 1 may be changed according to the type of vehicle and the type of tire.

$$Y = {a}_{1} {X}_{1} + {a}_{2} {X}_{2} + {a}_{3} {X}_{3} - {a}_{4} {X}_{4} - {a}_{5} {X}_{5} + {a}_{6} {X}_{6} + {a}_{7} {X}_{7} - {a}_{8} {X}_{8} - {a}_{9} {X}_{9} - {a}_{10} {X}_{10} + {a}_{11} {X}_{11} + {a}_{12} {X}_{12} + {a}_{13} {X}_{13} - {a}_{14} {X}_{14} - {a}_{15} {X}_{15} + {a}_{16} {X}_{16} - {a}_{17} {X}_{17} - {a}_{18} {X}_{18} + {a}_{19} {X}_{19} - {a}_{20} {X}_{20} - {a}_{21} {X}_{21} + {a}_{22} {X}_{22} - {a}_{23} {X}_{23} + {a}_{24} {X}_{24} + {a}_{25} {X}_{25} - {a}_{26} {X}_{26} + {a}_{27} {X}_{27} - {a}_{28} {X}_{28} - {a}_{29} {X}_{29} + {a}_{30} {X}_{30} + {a}_{31} {X}_{31} - {a}_{32} {X}_{32} + {a}_{33} {X}_{33} - {a}_{34} {X}_{34} + {a}_{35} {X}_{35} - {a}_{36} {X}_{36} + {a}_{37} {X}_{37} + 0.601 \qquad Equation 1$$

In Equation 1, a₁ to a₃₇ are constants as weights.

When Huber regressor is selected as the optimal regression model, the controller 40 may estimate the wear amount (Y) of a tire corresponding to the driver's driving pattern based on, for example, the following Equation 2. In this case, Equation 2 may be changed according to the type of vehicle and the type of tire.

$$Y = - {b}_{1} {X}_{1} + {b}_{2} {X}_{2} + {b}_{3} {X}_{3} - {b}_{4} {X}_{4} + {b}_{5} {X}_{5} + {b}_{6} {X}_{6} + {b}_{7} {X}_{7} + {b}_{8} {X}_{8} - {b}_{9} {X}_{9} - {b}_{10} {X}_{10} + {b}_{11} {X}_{11} - {b}_{12} {X}_{12} - {b}_{13} {X}_{13} - {b}_{14} {X}_{14} - {b}_{15} {X}_{15} + {b}_{16} {X}_{16} - {b}_{17} {X}_{17} - {b}_{18} {X}_{18} + {b}_{19} {X}_{19} - {b}_{20} {X}_{20} + {b}_{21} {X}_{21} + {b}_{22} {X}_{22} - {b}_{23} {X}_{23} - {b}_{24} {X}_{24} + {b}_{25} {X}_{25} - {b}_{26} {X}_{26} + {b}_{27} {X}_{27} - {b}_{28} {X}_{28} + {b}_{29} {X}_{29} + {b}_{30} {X}_{30} + {b}_{31} {X}_{31} - {b}_{32} {X}_{32} + {b}_{33} {X}_{33} - {b}_{34} {X}_{34} + {b}_{35} {X}_{35} - {b}_{36} {X}_{36} + {b}_{37} {X}_{37} + 0.602 \qquad Equation 2$$

In Equation 1, b₁ to b₃₇ are constants as weights.

Hereinafter, the factors used in Equation 1 and Equation 2 are defined as follows.

X₁ represents braking energy and represents a value obtained by subtracting the kinetic energy at the end of a brake operation from the kinetic energy at the start of the brake operation. For reference, when braking energy is calculated for 100 seconds in units of 1 second, braking energy in a time period in which braking does not occur becomes zero.

X₂ is the amount (W) of work while the brake is operating, and the controller 40 may calculate it based on following Equation 3. For reference, because the weights of vehicles are the same, the weight of a vehicle is not taken into account when calculating the amount of work.

W=|longitudinal acceleration×vehicle speed|+|lateral acceleration×yaw rate×vehicle speed| Equation 3:

In Equation 3, ∥ represents an absolute value.

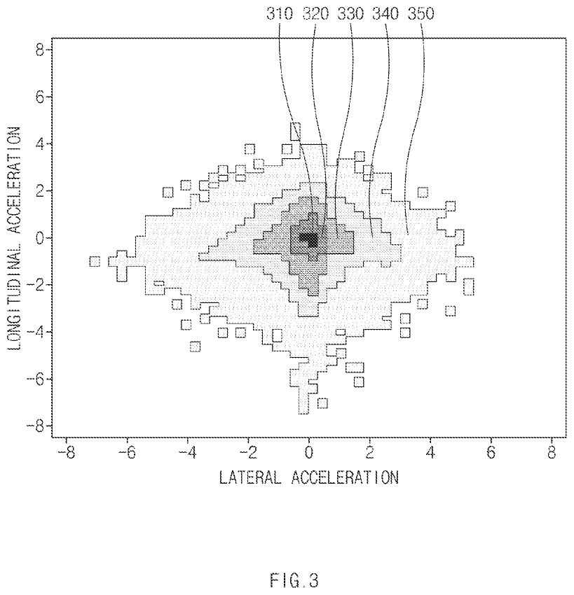

X₃ to X₇ represent the count ratio of the longitudinal acceleration-lateral acceleration region and will be described in detail with reference to FIG. 3.

FIG. 3 is a diagram illustrating a count ratio of a longitudinal acceleration-lateral acceleration region determined by a controller provided in an apparatus for estimating a wear amount of a tire according to an embodiment of the present disclosure.

In FIG. 3, the vertical axis represents the longitudinal acceleration, the horizontal axis represents the lateral acceleration, and a region composed of the longitudinal acceleration and the lateral acceleration forms a plurality of grids having a size of 0.02 m/s².

33.2% of a plurality of points corresponding to the longitudinal acceleration and lateral acceleration collected in units of 1 second, for example, during a preset time is included in a first grid 310, 44.5% is included in a second grid 320, 15.8% is included in a third grid 330, 4.1% is included in a fourth grid 340, and 0.8% is included in a fifth grid 350.

Accordingly, X₃ is 33.2 as a ratio of points included in the first grid 310, X₄ is 44.5 as a ratio of points included in the second grid 320, X₅ is 15.8 as a ratio of points included in the third grid 330, X₆ is 4.1 as a ratio of points included in the fourth grid 340, and X₇ is 0.8 as a ratio of points included in the fifth grid 350.

X₈ to X₁₁ are variables representing the number of times each gear ratio is set while the brake is operating, where X₈ represents the number of times the park (P) and neutral (N) stages are set, X₉ represents the number of times a random gear ratio is set among gear ratios greater than or equal to the first gear ratio and less than the fifth gear ratio, X₁₀ represents the number of times a random gear ratio is set among gear ratios greater than or equal to the fifth gear ratio and less than the ninth gear ratio, and X₁₁ represents the number of times that the ninth gear ratio or higher is set. For example, it is assumed that the brake is operated for 10 seconds, the third gear ratio is set from the 1st second to the 7th second, and the fifth gear ratio is set from the 8th second to the 10th second. When data is collected in units of 1 second, the third gear ratio is collected 7 times, and the fifth gear ratio is collected 3 times. Therefore, X₉ is ‘7’ and X₁₀ is ‘3’. In this case, X₈ and X₁₁ become ‘0 (zero)’.

X₁₂ to X₁₇ are variables representing the number of times each steering angle is collected while the brake is operating, where X₁₂ represents the number of times the steering angle is included in the section where the steering angle is less than −90 (zero) degrees, X₁₃ represents the number of times the steering angle is included in the section where the steering angle is more than −90 (zero) degrees and less than −45 degrees, X₁₄ represents the number of times the steering angle is included in the section where the steering angle is greater than or equal to −45 degrees and less than 0 (zero) degrees, X₁₅ represents the number of times the steering angle is included in the section where the steering angle is greater than or equal to 0 (zero) degrees and less than 45 degrees, X₁₆ represents the number of times the steering angle is included in the section where the steering angle is greater than or equal to 45 degrees and less than 90 (zero) degrees, and X₁₇ represents the number of times included in the section where the steering angle is 90 (zero) degrees or more. For example, it is assumed that the brake is applied for 10 seconds, the steering angle is −60 (zero) degrees from the 1st second to the 3rd second, the steering angle is −30 (zero) degrees from the 4th second to the 7th second, and the steering angle is 0 from the 8th second to the 10th second. When the steering angle is collected in units of 1 second, −60 (zero) degrees is collected 3 times, −30 (zero) degrees is collected 4 times, and 0 (zero) degrees is collected 3 times. Therefore, X₁₃ is 3, X₁₄ is 4, and X₁₅ is 3. In this case, X₁₂, X₁₆, and X₁₇ become ‘0 (zero)’.

X₁₈ to X₂₁ are variables representing the number of times each slope is collected while the brake is operating, where X₁₈ represents the number of times the slope is included in the section where the slope is less than −5 degrees, X₁₉ represents the number of times the slope is included in the section where the slope is equal to or more than −5 degrees and less than 0 (zero) degrees, X₂₀ represents the number of times the slope is included in the section where the slope is equal to or more than 0 (zero) degrees and less than 5 degrees, and X₂₁ represents the number of times the slope is included in the section where the slope is equal to or more than 5 degrees. For example, it is assumed that the brake is applied for 10 seconds, the slope is −3 degrees from the 1st second to the 7th second, and the slope is 0 (zero) degrees from the 8th second to the 10th second. When data is collected in units of 1 second, −3 degrees is collected 7 times and 0 (zero) degrees is collected 3 times. Therefore, X₁₉ is 7 and X₂₀ is 3. In this case, X₁₈ and X₂₁ become 0 (zero).

X₂₂ to X₂₅ are variables representing the number of times each yaw rate is collected while the brake is operating, where X₂₂ represents the number of times the yaw rate is included in the section where the yaw rate is less than −5, X₂₃ represents the number of times the yaw rate is included in the section where the yaw rate is equal to or more than −5 and less than 0 (zero), X₂₄ represents the number of times the yaw rate is included in the section where the yaw rate is equal to or more than 0 (zero) and less than 5, and X₂₅ represents the number of times the yaw rate is included in the section where the yaw rate is equal to or more than 5.

X₂₆ to X₃₀ are variables representing the number of times each vehicle speed is collected while the brakes were operating, where X₂₆ represents the number of times a stop state occurs, X₂₇ represents the number of times the vehicle speed is included in the section where the vehicle speed is less than 20 km/h, X₂₈ represents the number of times the vehicle speed is included in the section where the vehicle speed is equal to or more than 20 km/h and less than 50 km/h, X₂₉ represents the number of times the vehicle speed is included in the section where the vehicle speed is equal to or more than 50 km/h and less than 100 km/h, and X₃₀ represents the number of times the vehicle speed is included in the section where the vehicle speed is equal to or more than 100 km/h.

X₃₁ to X₃₃ are variables representing the number of times the air pressure of each tire of the right front wheel is collected while the brake is operating, where X₃₁ represents the number of times the right front wheel tire pressure is included in the section where the right front wheel tire pressure is less than 38, X₃₂ represents the number of times the right front wheel tire pressure is included in the section where the right front wheel tire pressure is equal to or more than 38 and less than 41, and X₃₃ represents the number of times the right front wheel tire pressure is included in the section where the right front wheel tire pressure is 41 or more.

X₃₄ to X₃₆ are variables representing the number of times the air pressure of each tire of the left front wheel is collected while the brake was operating, where X₃₄ represents the number of times the left front wheel tire pressure is included in the section where the left front wheel tire pressure is less than 38, X₃₅ represents the number of times the left front wheel tire pressure is included in the section where the left front wheel tire pressure is equal to or more than 38 and less than 41, and X₃₆ represents the number of times the left front wheel tire pressure is 41 or more.

X₃₇ represents the mileage of the vehicle.

Meanwhile, when Bayesian Ridge regression is selected as the optimal model among the regression models, among the factors that determine the driving pattern of the driver, the order of having a large effect on the wear amount of the tire is X₃₇, X₂₇, X₂₅, X₃₃, X₃₀, X₃₁, X₂, X₁₁, X₁₉, X₁₆. This indicates the order of higher weights.

In addition, when the Huber regressor is selected as the optimal model among the regression models, among the factors that determine the driver's driving pattern, the order of having a significant effect on the amount of tire wear is X₂₇, X₂₁, X₃₇, X₃₃, X₁₆, X₂, X₁₁, X₃₁, X₂₂, X₁₉. This indicates the order of higher weights.

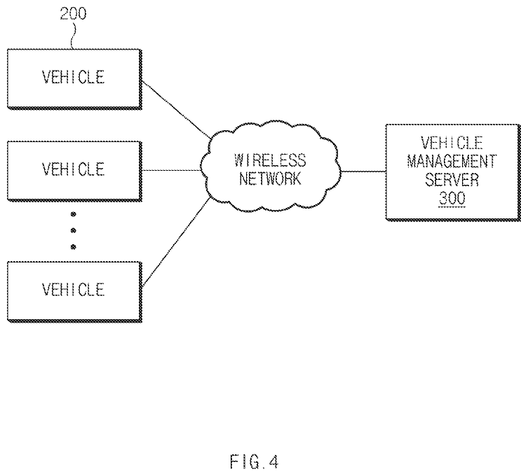

FIG. 4 is a block diagram illustrating a vehicle management system to which an apparatus for estimating a wear amount of a tire according to an embodiment of the present disclosure is applied.

As shown in FIG. 4, a vehicle management system may include a plurality of vehicles 200 and the vehicle management server 300.

As a first embodiment, the apparatus 100 for estimating a wear amount of a tire may be provided in each vehicle 200 to estimate the wear amount of the tire corresponding to the driving pattern of the driver.

As a second embodiment, the apparatus 100 for estimating a wear amount of a tire, which is provided in the vehicle management server 300, may receive factors (X₁˜X₃₇) used to grasp the driving pattern of the driver from each vehicle 200, and based on the factors, determine the wear amount of the tire corresponding to the driving pattern of the driver for each vehicle.

Each vehicle 200 may include at least one of a mobile communication module, a wireless Internet module, and a short-range communication module, which is a module providing a communication interface with the vehicle management server 300.

The mobile communication module may communicate with the vehicle management server 300 through a mobile communication network constructed according to a technical standard or communication scheme for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTEA), and the like).

The wireless Internet module, which is a module for wireless Internet access, may communicate with the vehicle management server 300 through wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and the like.

The short-range communication module may support short-range communication with the vehicle management server 300 by using at least one of Bluetooth™, radio frequency identification (RFID), infrared data association (IrDA), ultra wideband (UWB), ZigBee, near field communication (NFC), and wireless universal serial bus (USB) technology.

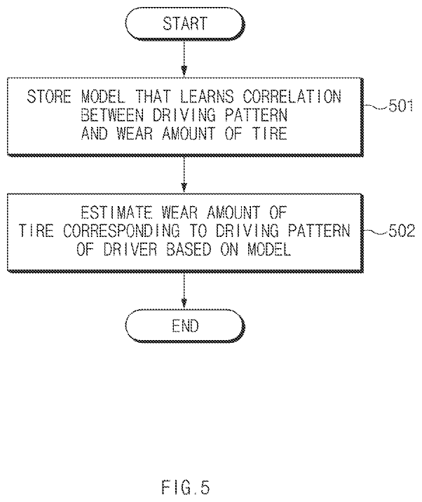

FIG. 5 is a flowchart of a method of estimating a wear amount of a tire according to an embodiment of the present disclosure.

First, in 501, the memory 10 stores the model that learns a correlation between the driving pattern and the wear amount of a tire.

Then, in 502, the controller 40 estimates the wear amount of the tire corresponding to the driving pattern of the driver based on the model. To this end, the controller 40 may collect at least one of a longitudinal acceleration, a lateral acceleration, a gear ratio, a steering angle, a slope, a yaw rate, a vehicle speed, a tire air pressure, a mileage, or a combination thereof through a vehicle network. In addition, the controller 40 may grasp the driving pattern of the driver based on at least one of braking energy, a count ratio of longitudinal acceleration-lateral acceleration, an amount of work, a gear ratio, a steering angle, a slope, a yaw rate, a vehicle speed, a right front wheel tire air pressure, a left front wheel tire air pressure, a mileage, or a combination thereof.

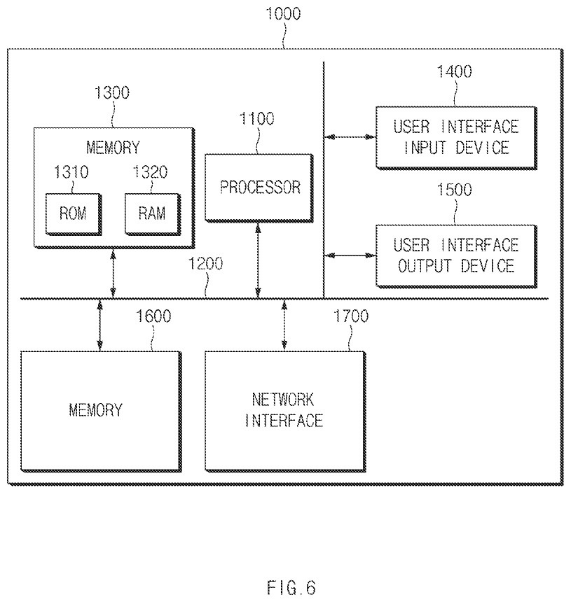

FIG. 6 is a block diagram illustrating a computing system for executing a method of estimating a wear amount of a tire according to an embodiment of the present disclosure.

Referring to FIG. 6, a method of estimating a wear amount of a tire according to an embodiment of the present disclosure described above may be implemented through a computing system. A computing system 1000 may include at least one processor 1100, a memory 1300, a user interface input device 1400, a user interface output device 1500, a memory (i.e., a storage) 1600, and a network interface 1700 connected through a bus 1200.

The processor 1100 may be a central processing device (CPU) or a semiconductor device that processes instructions stored in the memory 1300 and/or the memory 1600. The memory 1300 and the memory 1600 may include various types of volatile or non-volatile storage media. For example, the memory 1300 may include a ROM (read only memory) 1310 and a RAM (random access memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the memory 1600), such as a RAM, a flash memory, a ROM, an EPROM, an EEPROM, a register, a hard disk, a solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to one embodiment of the present disclosure, a model that learns a correlation between a driving pattern of a driver and a wear amount of a tire is provided and a wear amount of a tire corresponding to a driving pattern of a driver is estimated based on the model, so that it is possible to estimate a tire replacement time with high accuracy without requiring the driver to frequently check the wear amount of the tire before driving, and a method thereof.

According to another embodiment of the present disclosure, a model that learns a correlation between a driving pattern of a driver and a wear amount of a tire is provided, a wear amount of a tire corresponding to a driving pattern of a driver is estimated based on the model, and the wear amount of the tire is provided to the driver, so that the driver may easily check the tire condition at any time even while driving, and a method thereof.

According to still another embodiment of the present disclosure, a model that learns a correlation between a driving pattern of a driver and a wear amount of a tire is provided, and a wear amount of a tire corresponding to a driving pattern of a driver is estimated based on the model, so that it is possible to notify the driver of tire replacement when the wear amount of the tire exceeds a threshold value, thereby allowing the driver to replace the tire at an appropriate tire replacement time.

According to still another embodiment of the present disclosure, a model that learns a correlation between a driving pattern of a driver and a wear amount of a tire is provided, a wear amount of a tire corresponding to a driving pattern of a driver is estimated based on the model, and the wear amount of the tire is provided to an external vehicle management server, so that the vehicle management server may provide a potentiometer service, an aftermarket service, or a tire replacement reservation service for each vehicle.

Although exemplary embodiments of the present disclosure have been described for illustrative purposes, those skilled in the art will appreciate that various modifications, additions and substitutions are possible, without departing from the scope and spirit of the disclosure. Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for estimating a wear amount of a tire, the apparatus comprising:
a memory storing a model configured to learn a correlation between a driving pattern and the wear amount of the tire; and
a controller configured to estimate the wear amount of the tire corresponding to the driving pattern of a driver based on the model.

2. The apparatus of claim 1, wherein the controller is configured to collect at least one of a longitudinal acceleration, a lateral acceleration, a gear ratio, a steering angle, a slope, a yaw rate, a vehicle speed, a tire air pressure, a mileage, or a combination thereof through a vehicle network.

3. The apparatus of claim 2, wherein the model comprises Bayesian Ridge regression or Huber regressor.

4. The apparatus of claim 1, wherein:
the model comprises Bayesian Ridge regression; and
the controller is configured to:
collect a mileage through a vehicle network;
collect a longitudinal acceleration, a lateral acceleration, a gear ratio, a steering angle, a slope, a yaw rate, a vehicle speed, or a tire air pressure through the vehicle network; and
assign a highest weight to the mileage.

5. The apparatus of claim 1, wherein:
the model comprises Huber regressor;
the controller is configured to:
collect a vehicle speed through a vehicle network;
collect a longitudinal acceleration, a lateral acceleration, a gear ratio, a steering angle, a slope, a yaw rate, a tire air pressure, or a mileage through the vehicle network; and
assign a highest weight to the vehicle speed.

6. The apparatus of claim 1, wherein the controller is configured to grasp the driving pattern of the driver based on at least one of a braking energy, a count ratio of longitudinal acceleration-lateral acceleration, an amount of work, a gear ratio, a steering angle, a slope, a yaw rate, a vehicle speed, a right front wheel tire air pressure, a left front wheel tire air pressure, a mileage, or a combination thereof.

7. The apparatus of claim 1, wherein the controller is configured to provide the wear amount of the tire to the driver.

8. The apparatus of claim 1, wherein the controller is configured to warn the driver to replace the tire when the wear amount of the tire exceeds a threshold value.

9. The apparatus of claim 1, wherein the controller is configured to provide the wear amount of the tire to a vehicle management server.

10. The apparatus of claim 1, wherein the memory is configured to store different models corresponding to a type of vehicle and a type of tire.

11. A method of estimating a wear amount of a tire, the method comprising:
storing in a memory a model that learns a correlation between a driving pattern and the wear amount of the tire; and
estimating by a controller the wear amount of the tire corresponding to the driving pattern of a driver based on the model.

12. The method of claim 11, wherein estimating the wear amount of the tire comprises collecting, by the controller, at least one of a longitudinal acceleration, a lateral acceleration, a gear ratio, a steering angle, a slope, a yaw rate, a vehicle speed, a tire air pressure, a mileage, or a combination thereof through a vehicle network.

13. The method of claim 12, wherein the model comprises Bayesian Ridge regression or Huber regressor.

14. The method of claim 11, wherein:
the model comprises Bayesian Ridge regression; and
estimating the wear amount of the tire comprises:
collecting, by the controller, a mileage through a vehicle network;
collecting, by the controller, a longitudinal acceleration, a lateral acceleration, a gear ratio, a steering angle, a slope, a yaw rate, a vehicle speed, or a tire air pressure through the vehicle network; and
assigning, by the controller, a highest weight to the mileage.

15. The method of claim 11, wherein:
the model comprises Huber regressor; and
estimating the wear amount of the tire comprises:
collecting, by the controller, a vehicle speed through a vehicle network;
collecting, by the controller, a longitudinal acceleration, a lateral acceleration, a gear ratio, a steering angle, a slope, a yaw rate, a tire air pressure, or a mileage through the vehicle network; and
assigning, by the controller, a highest weight to the vehicle speed.

16. The method of claim 11, wherein estimating the wear amount of the tire comprises grasping, by the controller, the driving pattern of the driver based on at least one of a braking energy, a count ratio of longitudinal acceleration-lateral acceleration, an amount of work, a gear ratio, a steering angle, a slope, a yaw rate, a vehicle speed, a right front wheel tire air pressure, a left front wheel tire air pressure, a mileage, or a combination thereof.

17. The method of claim 11, wherein estimating the wear amount of the tire comprises providing, by the controller, the wear amount of the tire to the driver.

18. The method of claim 11, wherein estimating the wear amount of the tire comprises warning, by the controller, the driver to replace the tire when the wear amount of the tire exceeds a threshold value.

19. The method of claim 11, wherein estimating the wear amount of the tire comprises providing, by the controller, the wear amount of the tire to a vehicle management server.

20. The method of claim 11, wherein storing the model comprises storing, by the memory, different models corresponding to a type of vehicle and a type of tire.
